(19) United States
(12) Patent Application Publication
(10) Pub. No.: US 2012/0292400 A1
(43) Pub. Date: Nov. 22, 2012

(54) AIR CONTROL SYSTEM

(76) Inventor: Jerry Weber, Jefferson, TX (US)

(21) Appl. No.: 13/111,947

(22) Filed: May 19, 2011

(51) Int. Cl. G05D 23/19

(52) U.S. Cl. 236/93 R

(57) ABSTRACT

The present invention is an air control system utilized by a building and the building's HVAC system that includes a computerized thermostat with a plurality of location indicia that indicate a specific room or area of the house or building and a plurality of temperature indicia that indicate a temperature of the corresponding room or area indicated by the location indicia. The air control system also includes a valve system in communication with the thermostat placed in a duct of the HVAC system with an automated valve actuator and a valve controlled by the computerized thermostat. The system can be computerized and the valve is made of aluminum or other suitable material.

### TECHNICAL FIELD & BACKGROUND

Conventional central air conditioning units and air duct layouts are designed to evenly cool or heat all areas of a home. Cooling or heating areas of a home while not being utilized can consume inordinate amounts of energy and money.

The present invention generally relates to a control system. More specifically, the invention is an air control system.

It is an object of the invention to provide an air control system that utilizes a plurality of aluminum valves located at the entrance of one or more air ducts, which controls the amount of air flow traveling to specific areas of a home or other air controlled building.

What is really needed is an air control system that utilizes a plurality of aluminum valves located at the entrance of one or more air ducts, which controls the amount of air flow traveling to specific areas of a home or other air controlled building.

### BRIEF DESCRIPTION OF THE DRAWINGS

The present invention will be described by way of exemplary embodiments, but not limitations, illustrated in the accompanying drawings in which like references denote similar elements, and in which:

FIG. 1A illustrates a front perspective view of a computer thermostat of an air control system, in accordance with one embodiment of the present invention.

FIG. 1B illustrates a front perspective view of a valve system of an air control system, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is utilized repeatedly. The phrase generally does not refer to the same embodiment, however, it may. The terms “comprising”, “having” and “including” are synonymous, unless the context dictates otherwise.

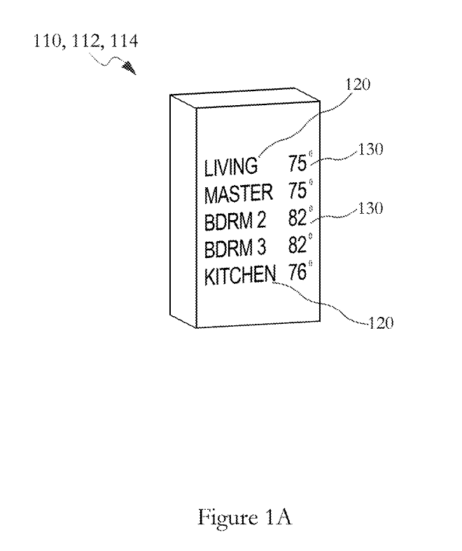

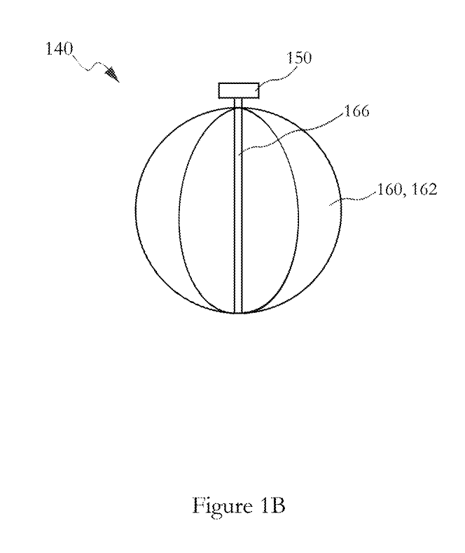

FIG. 1A illustrates a front perspective view of a computerized thermostat 110 of an air control system 100, in accordance with one embodiment of the present invention. The air control system 100 allows a user to direct the air flow of a heating and/or cooling system such as a HVAC system to specific areas of a house or other type of building. The air control system 100 includes a computerized thermostat 110 with a plurality of location indicia 120 and a plurality of temperature indicia 130.

The computerized thermostat 110 controls the temperature of all of the areas that are cooled or heated by the heating and/or cooling system of a building. The location indicia 120, indicates the specific room or area of a building that the air control system 100 is controlling. The temperature indicia 130, indicates the temperature of the corresponding room or area indicated by the location indicia 120. The computerized thermostat 110 can be digital 112 or analog 114.

FIG. 1B illustrates a front perspective view of a valve system 140 of an air control system 100, in accordance with one embodiment of the present invention. The valve system 140 is placed at the entrance of a duct of the heating and/or cooling system of the building being controlled by the air control system 100. The valve system 140 includes an automated valve actuator 150 and a valve 160.

The automated valve actuator 150 is in communication with the computerized thermostat 110 to control the temperature of the house or building. The valve 160 is activated by the automated valve actuator 150 and is controlled by the computerized thermostat 110 through control of the automated valve actuator 150. The valve 160 is made of aluminum but can be made of any other suitable material. Other suitable types of valves can also be utilized with the valve system 140.

The air control system utilizes a computerized thermostat and a plurality of automated valves for the air ducts of the heating and/or cooling system of any suitable building, affording the user a relatively better alternative for distributing controlled air flow. When in operation, the air control system designates specific temperatures for each area of the home or building appearing on the computerized thermostat and the automated valve actuators initiate the valve system to direct the air flow as specified. The air control system can be utilized by HVAC manufacturers, homeowners and building superintendents to provide energy savings and reduced costs. The air control system features a valve system of aluminum valves located at the entrance of the air ducts of the heating and/or cooling system, which controls the amount of air flow traveling to each specific area of a home. The air control system is designed to be incorporated into new and existing homes, buildings and heating and/or cooling systems with only minor suitable modifications.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. An air control system utilized by a building and said building HVAC system, comprising:
a thermostat with a plurality of location indicia that indicate a specific room or area of said building and a plurality of temperature indicia that indicate a temperature of said corresponding room or area indicated by said location indicia; and
a valve system in communication with sad thermostat placed in a duct of said HVAC system with an automated valve actuator and a valve controlled by said computerized thermostat,

2. The system according to claim 1, wherein said thermostat is computerized,

3. The system according to claim 2, wherein said thermostat has a digital display.

4. The system according to dam 1, wherein said thermostat has an analog display.

5. The system according to claim 1, wherein said valve system is placed at an entrance of said duct.

6. The system according to dam 1, wherein said building is a house.

7. An air control system utilized by a building and said building HVAC system, comprising:
a computerized thermostat with a plurality of location indicia that indicate a specific room or area of said building and a plurality of temperature indicia that indicate a temperature of said corresponding room or area indicated by said location indicia; and
a valve system in communication with said thermostat placed in a duct of said HVAC system with an automated valve actuator and a valve controlled by said computerized thermostat.

8. The system according to claim 7, wherein said thermostat has a digital display.

9. The system according to claim 7, wherein said thermostat has an analog display.

10. The system according to claim 7, wherein said valve system is placed at an entrance of said duct.

11. The system according to claim 7, wherein said valve is a multiple fin valve.

12. The system according to claim 11, wherein said multiple fin valve rotates around an axis controlled by said automated valve actuator.

13. An air control system utilized by a building and said building HVAC system, comprising:
a computerized thermostat with a plurality of location indicia that indicate, a specific room or area of said building and a plurality of temperature indicia that indicate a temperature of said corresponding room or area indicated by said location indicia; and
a valve system in communication with said thermostat placed in a duct of said HVAC system with an automated valve actuator and a valve controlled by said computerized thermostat.

14. The system according to claim 13, wherein said thermostat has a digital display.

15. The system according to claim 13, wherein said thermostat has an analog display.

16. The system according to claim 13, wherein said valve system is placed at an entrance of said duct.

17. The system according to claim 13, wherein said valve is a multiple fin valve.

18. The system according to claim 17, wherein said multiple fin valve rotates around an axis controlled by said automated valve actuator.

19. The system according to claim 18, wherein said multiple fin valve is made of aluminum.

20. The system according to claim 13, wherein said building is a house.
